(19) United States
(12) Patent Application Publication
(10) Pub. No.: US 2026/0036759 A1
(43) Pub. Date: Feb. 5, 2026

(54) CO-PACKAGED PHOTONICS FIBER CONNECTOR

(71) Applicant: ACON OPTICS COMMUNICATIONS INC., New Taipei City (TW)

(72) Inventors: Jia Rong Wu, New Taipei City (TW); Tsung Yao Hsu, New Taipei City (TW)

(73) Assignee: ACON OPTICS COMMUNICATIONS INC., New Taipei City (TW)

(21) Appl. No.: 19/287,734

(22) Filed: Jul. 31, 2025

Related U.S. Application Data
(60) Provisional application No. 63/678,558, filed on Aug. 2, 2024.

(51) Int. Cl. G02B 6/38

(52) U.S. Cl. CPC G02B 6/3831; G02B 6/3897

(57) ABSTRACT

A co-packaged photonics fiber connector, disposed on a photonic integrated circuit (PIC) for receiving an optical fiber assembly and optically coupling the optical fiber assembly to the PIC, includes a housing mounted on the PIC and including a slot, an intermediate member to be inserted into or removed from the slot and including a shaft portion, and a spring sheet. A portion of the spring sheet is pivotally connected to the shaft portion to pivotally rotate relative to the intermediate member. In a fixed state, the optical fiber assembly is inserted into the slot together with the intermediate member that covers the optical fiber assembly, another portion of the spring sheet is locked with the housing to assemble the intermediate member and the housing together, and the spring sheet presses the optical fiber assembly through the intermediate member to secure the optical fiber assembly in the slot of the housing.

### CROSS-REFERENCE TO RELATED APPLICATION

This application claims the priority benefit of U.S. provisional application Ser. No. 63/678,558, filed on Aug. 2, 2024. The entirety of the above-mentioned patent application is hereby incorporated by reference herein and made a part of this specification.

### BACKGROUND

### Technical Field

The disclosure relates to a photonics connector, and particularly relates to a co-packaged photonics fiber connector.

### Description of Related Art

Co-packaged optics (CPO) refer to a technology in which optical elements and electronic components are co-packaged on the same substrate, intended to improve data transmission efficiency, minimize power consumption and cost, and shrink system size. The CPO reduces losses caused by optical signals in traditional packaging by more closely integrating optical elements into electronic chips and enhances both signal transmission speed and bandwidth. Additionally, by shortening optical signal transmission paths, the CPO can further reduce the energy required for signal transmission, thereby decreasing overall power consumption.

### SUMMARY

The disclosure provides a co-packaged photonics fiber connector that enables an optical fiber assembly and a photonic integrated circuit (PIC) to be rapidly combined with or separated from each other through the assembly and disassembly of a fixing mechanism, without damage to the optical fiber assembly.

A co-packaged photonics fiber connector of the disclosure is disposed on a PIC and configured to receive an optical fiber assembly and optically couple the optical fiber assembly to the PIC. The co-packaged photonics fiber connector includes a housing, an intermediate member, and a spring sheet. The housing is mounted on the PIC and includes a slot. The intermediate member is configured to be inserted into the slot or removed from the slot, and the intermediate member includes a shaft portion. A portion of the spring sheet is pivotally connected to the shaft portion to pivotally rotate relative to the intermediate member. In a fixed state, the optical fiber assembly is inserted into the slot, the intermediate member is inserted into the slot and covers the optical fiber assembly, another portion of the spring sheet is locked with the housing to assemble the intermediate member and the housing together, and the spring sheet presses the optical fiber assembly through the intermediate member to secure the optical fiber assembly in the slot of the housing.

Based on the above, in the co-packaged photonics fiber connector, the spring sheet is assembled to the intermediate member and is able to pivotally rotate relative to the housing. After the optical fiber assembly is inserted into the slot together with the intermediate member that covers the optical fiber assembly, the spring sheet is pivotally rotated and locked with the housing. That is, the housing and the intermediate member are locked together through the spring sheet, so that an elastic force of the spring sheet may press the optical fiber assembly through the intermediate member to secure the optical fiber assembly in the slot of the housing. Such an arrangement not only allows the optical fiber assembly and the PIC to achieve the rapid assembly and disassembly through the cooperation between the spring sheet, housing, and intermediate member, but also ensures that the spring sheet pivoted to the intermediate member may hook onto the housing to provide an effective binding force after the intermediate member is inserted into the slot. More importantly, the spring sheet is only locked with and abutted against the housing and the intermediate member, and will not have direct structural contact with the optical fiber assembly. Therefore, it may effectively achieve the purpose of protecting the optical fiber assembly through the intermediate member, thereby further providing a stable assembly mechanism for the optical fiber assembly and the PIC and improving the lifetime of the optical fiber assembly.

### BRIEF DESCRIPTION OF THE DRAWINGS

FIG. 1A is a schematic view of a co-packaged photonics fiber connector according to an embodiment of the disclosure.

FIG. 1B illustrates the co-packaged photonics fiber connector of FIG. 1A from another viewing angle.

FIG. 1C illustrates another state of the co-packaged photonics fiber connector of FIG. 1A.

FIG. 2 is an exploded view of a co-packaged photonics fiber connector.

FIG. 3 and FIG. 4A respectively illustrate a part of the components of a co-packaged photonics fiber connector from different viewing angles.

FIG. 4B illustrates an intermediate member from another viewing angle.

FIG. 5A and FIG. 5B are cross-sectional views of a co-packaged photonics fiber connector at different degrees respectively.

FIG. 5C illustrates a partial view of the co-packaged photonics fiber connector of FIG. 1A.

FIG. 6 is a schematic view of a co-packaged photonics fiber connector according to another embodiment of the disclosure.

FIG. 7 illustrates an exploded view of the co-packaged photonics fiber connector of FIG. 6.

### DESCRIPTION OF THE EMBODIMENTS

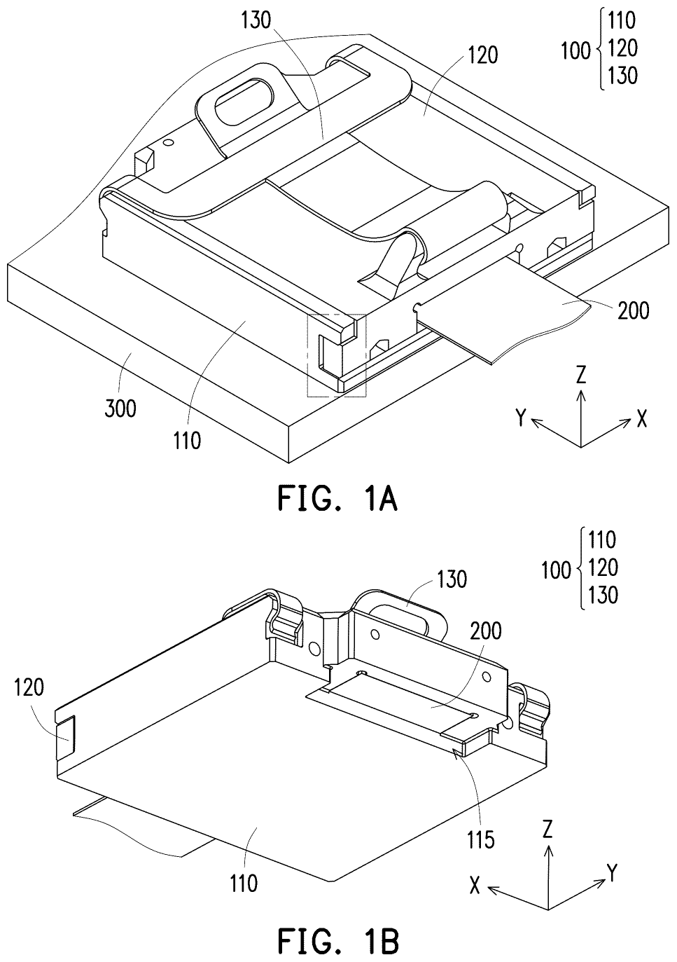

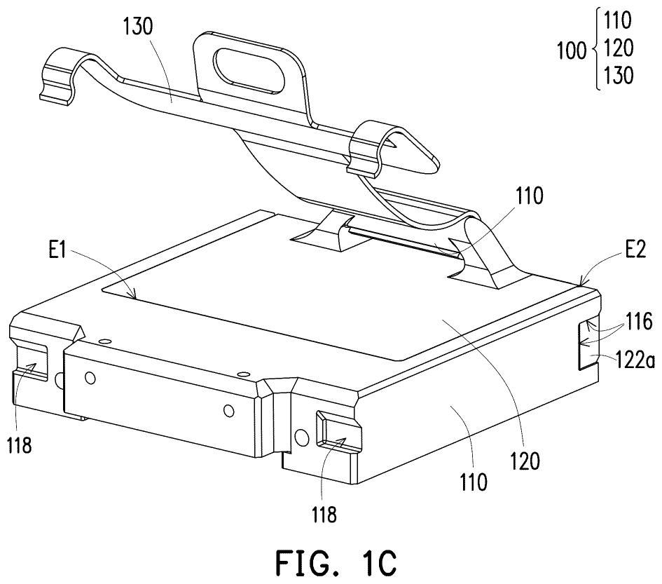

FIG. 1A is a schematic view of a co-packaged photonics fiber connector according to an embodiment of the disclosure. FIG. 1B illustrates the co-packaged photonics fiber connector of FIG. 1A from another viewing angle. FIG. 1C illustrates another state of the co-packaged photonics fiber connector of FIG. 1A. Rectangular coordinates X-Y-Z are provided at the same time to facilitate component description. Referring to FIG. 1A to FIG. 1C at the same time, in the embodiment, a co-packaged photonics fiber connector 100 is disposed on a photonic integrated circuit (PIC) 300 and configured to receive an optical fiber assembly 200 and optically couple the optical fiber assembly 200 to the PIC 300. The co-packaged photonics fiber connector 100 includes a housing 110, an intermediate member 120, and a spring sheet 130. After being assembled to the housing 110, the intermediate member 120 and the optical fiber assembly 200 are locked with the housing 110 through the spring sheet 130 so that the housing 110 and the intermediate member 120 are combined together, and the optical fiber assembly 200 is pressed therebetween accordingly.

Here, the PIC 300 utilizes semiconductor processes to directly fabricate optical elements such as modulators, switches, splitters, etc., in an integrated circuit, forming a compact optoelectronic integrated circuit element. In contrast to electronic integrated circuits, which transmit electrons, integrated optical elements mainly transmit optical signals in visible light or infrared wavelengths, and the connection of various elements in the circuit is completed by optical waveguides. Through such miniaturized, highly stable integrated optical elements, optoelectronic communication systems are able to demonstrate increasingly greater functionality and efficacy.

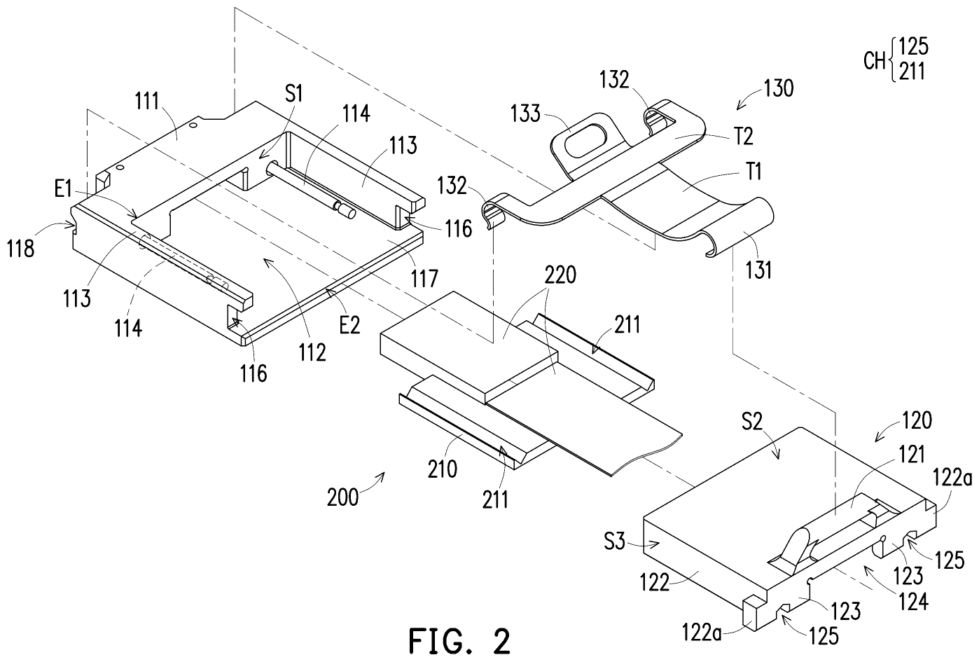

FIG. 2 is an exploded view of a co-packaged photonics fiber connector. Referring to FIG. 1A and FIG. 2 at the same time, the housing 110 is further mounted on the PIC 300 and includes a slot 112. The intermediate member 120 is configured to be inserted into the slot 112 or removed from the slot 112, and the intermediate member 120 includes a shaft portion 121. A portion of the spring sheet 130 is pivotally connected to the shaft portion 121 to pivotally rotate relative to the intermediate member 120. In a fixed state, the optical fiber assembly 200 is inserted into the slot 112, the intermediate member 120 is inserted into the slot 112 and covers the optical fiber assembly 200, and another portion of the spring sheet 130 is locked with the locking portion 118 of the housing 110 to assemble the intermediate member 120 and the housing 110 together. The spring sheet 130 compresses the optical fiber assembly 200 through the intermediate member 120 to secure the optical fiber assembly 200 in the slot 112 of the housing 110. The embodiment takes the housing 110 being located on the X-Y plane as an example, in which the intermediate member 120 and the optical fiber assembly 200 move in the positive Y-axis direction to be inserted into the slot 112, and move in the negative Y-axis direction to be removed from the slot 112.

In detail, the housing 110 of the embodiment further includes a block 111 and a base plate 117. The block 111 includes an inner stop surface S1. The base plate 117 and two side walls 113 extend from the block 111 in the same direction (both toward the negative Y-axis direction) and form the slot 112 with the inner stop surface S1.

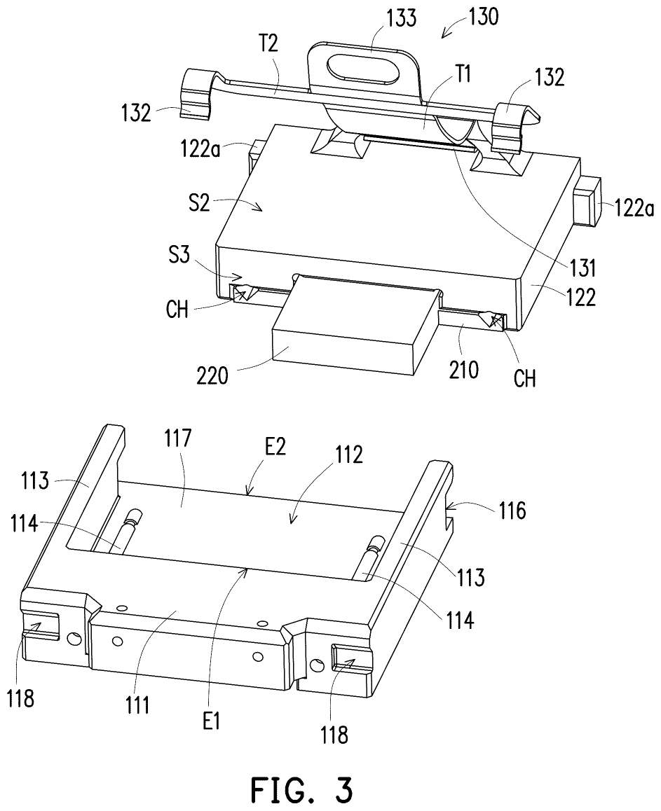

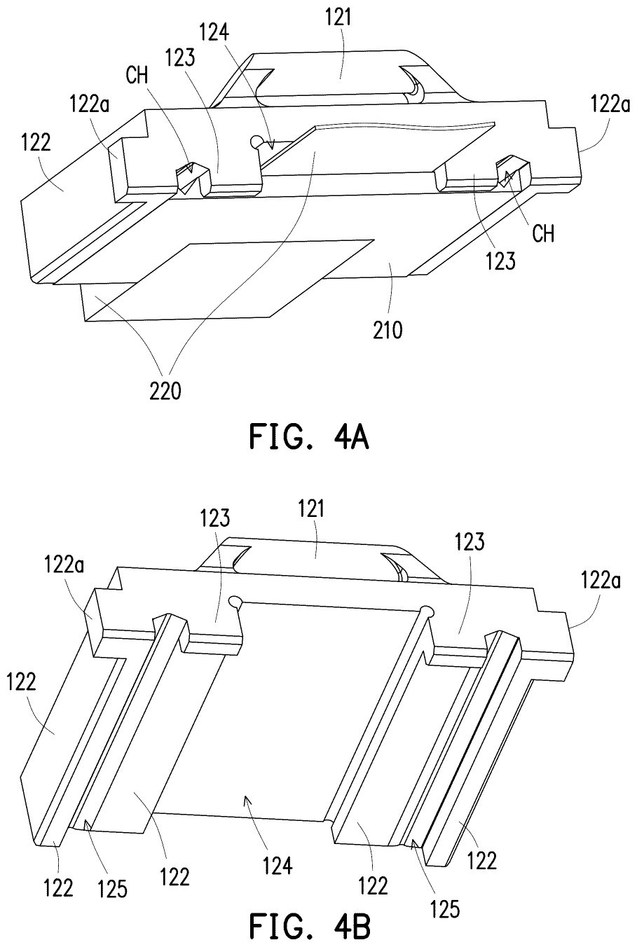

FIG. 3 and FIG. 4A respectively illustrate a part of the components of a co-packaged photonics fiber connector from different viewing angles. Referring to FIG. 1A, FIG. 2, and FIG. 3 first, the housing 110 includes two side walls 113 and an inner stop surface S1 forming the slot 112, the two side walls 113 are opposite to each other, and the inner stop surface S1 is adjacent between the two side walls 113. In the fixed state, an inner side surface S3 of the intermediate member 120 abuts the inner stop surface S1. Further, the slot 112 of the embodiment includes a first end E1 and a second end E2 opposite to each other. The optical fiber assembly 200 and the intermediate member 120 are configured to move from the second end E2 toward the first end E1 to be inserted into the slot 112, or move from the first end E1 toward the second end E2 to be removed from the slot 112. In the fixed state, the shaft portion 121 of the intermediate member 120 is located at the second end E2.

FIG. 4B illustrates an intermediate member from another viewing angle. Referring to FIG. 2, FIG. 4A, and FIG. 4B at the same time, FIG. 4A may be regarded as the state after the intermediate member 120 and the optical fiber assembly 200 have been inserted into the slot 112 (the housing 110 is omitted here), while FIG. 4B serves as a comparison of FIG. 4A with the optical fiber assembly 200 further omitted. In the embodiment, the intermediate member 120 has an inverted U-shaped structure and includes two abutting ribs 122 and a groove 124 located between the two abutting ribs 122. Correspondingly, the optical fiber assembly 200 includes an optical module 220 and a base 210, and the optical module 220 is disposed on the base 210. As shown in FIG. 4A, in the fixed state, the optical fiber assembly 200 is accommodated in the groove 124, and the abutting block 123 of the intermediate member 120 abuts the base 210. Corresponding to FIG. 1A or FIG. 2, when the intermediate member 120 is locked with the locking portion 118 of the housing 110 through the spring sheet 130, it is equivalent to providing a force in the positive Y-axis direction to the intermediate member 120 such that the abutting block 123 tightly abuts the base 210, and the inner side surface S3 of the intermediate member 120 tightly abuts the inner stop surface S1 of the housing 110, thereby smoothly causing the base 210 of the optical fiber assembly 200 to be clamped between the abutting block 123 and the inner stop surface S1. Here, the abutting block 123 may be regarded as extending from the structure of the abutting rib 122 and being located on the same side of the intermediate member 120 as the shaft portion 121 and arranged in an up-and-down manner along the Z-axis, as shown in FIG. 1A.

Furthermore, referring to FIG. 2, FIG. 3, and FIG. 4A again, the housing 110 further includes a first guide post 114, extending from the inner stop surface S1 along the side wall 113 within the slot 112, and at least one of the intermediate member 120 and the optical fiber assembly 200 includes a first guide slot configured to the first guide post 114. The embodiment uses the V-shaped slot 125 at the abutting rib 122 of the intermediate member 120 (as shown in FIG. 4B), combined with the V-shaped slot 211 on the wing portion of the base 210 of the optical fiber assembly 200 (as shown in FIG. 2), to jointly form a first guide slot CH of the disclosure. However, the disclosure is not limited thereto. In other embodiments not shown, the first guide post 114 may be appropriately adjusted so that one of the intermediate member 120 or the base 210 of the optical fiber assembly 200 includes the aforementioned first guide slot. In other words, any configuration that enables the optical fiber assembly 200 and the intermediate member 120 to smoothly move into the slot 112 of the housing 110 and achieve the required guiding and positioning effect may be applicable to the disclosure.

Referring to FIG. 2 again, the spring sheet 130 of the embodiment has a T-shape and includes a transverse section T2 and a straight section T1. The straight section T1 intersects at a center of the transverse section T2. One end of the straight section T1 away from the transverse section T2 includes a pivot portion 131. The pivot portion 131 may pivotally rotate to wrap around the shaft portion 121. Each of the two opposite ends of the transverse section T2 includes a hook 132. In the fixed state, the hook 132 is locked with an external structure (i.e. the locking portion 118) of the housing 110 facing away from the slot 112. The spring sheet 130 of the embodiment further includes a pull handle 133, extending from the center of the transverse section T2 and opposite to the straight section T1. The pull handle 133 facilitates user gripping for operating the spring sheet 130 to pivotally rotate relative to the intermediate member 120, thereby enabling engagement with the locking portion 118 or release therefrom.

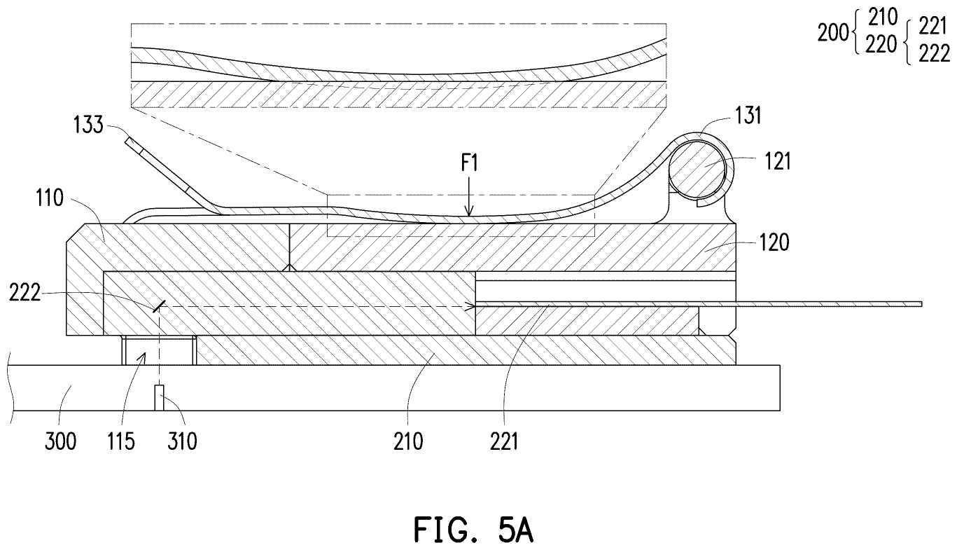

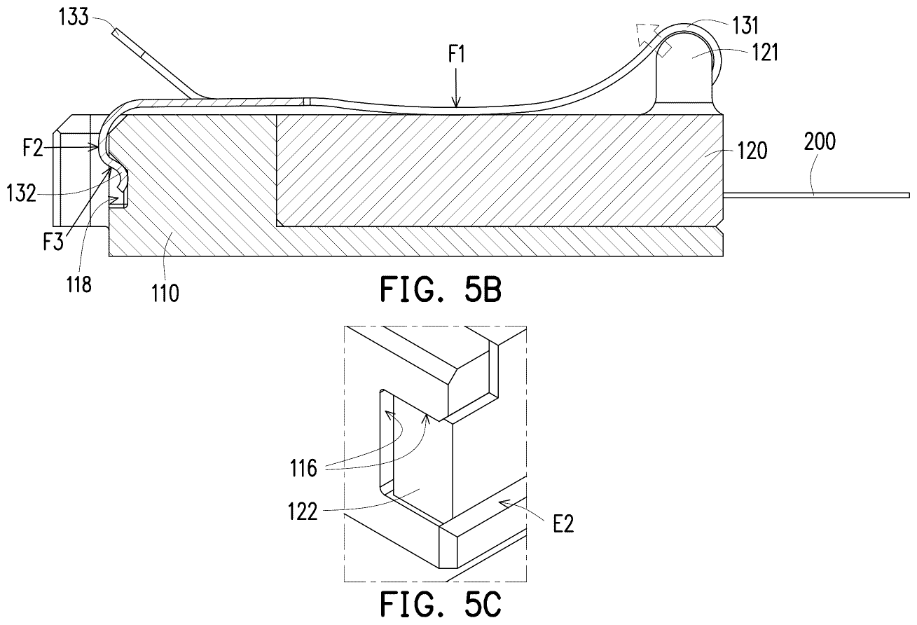

FIG. 5A and FIG. 5B are cross-sectional views of a co-packaged photonics fiber connector at different degrees respectively. Referring to FIG. 1B, FIG. 5A, and FIG. 5B at the same time, the housing 110 of the embodiment further includes a hollow portion 115, facing toward the PIC 300 and communicating with the slot 112. The optical module 220 of the embodiment includes fiber (array) 221 and optical element (array) 222, and the PIC 300 includes an optical waveguide 310. In the fixed state, the base 210 is located in the slot 112 and abuts the inner stop surface S1, the optical module 220 extends from the slot 112 to the hollow portion 115 to correspond to the PIC 300, and as shown in FIG. 5A, the optical fiber assembly 200 and the PIC 300 that complete optical coupling may transmit optical signals represented by dashed arrows from the optical waveguide 310 and optical element 222 to the fiber 221.

To smoothly achieve the aforementioned fixed state, the spring sheet 130 of the embodiment is in a bent original (unforced) state at its straight section T1. Therefore, in the fixed state, the straight section T1 deforms to accumulate the elastic force due to an interference with a top surface S2 of the intermediate member 120, such that a first force F1 is applied to the top surface S2 to press the intermediate member 120 in the slot 112, and also press the optical fiber assembly 200 covered by the intermediate member 120, so as to make the optical fiber assembly 200 substantially fixed between the intermediate member 120 and the slot bottom of the slot 112 (i.e., the aforementioned base plate 117). Furthermore, in the fixed state, the hook 132 of the spring sheet 130 also applies a second force F2 to the locking portion 118 of the housing 110, which is also equivalent to causing the pivot portion 131 of the spring sheet 130 to provide a reverse force to the intermediate member 120, which, in conjunction with the second force F2, causes the intermediate member 120 and the housing 110 to abut together along the Y-axis, thereby pressing the optical fiber assembly 200 between the intermediate member 120 and the housing 110. Accordingly, through the aforementioned force application of the spring sheet 130 to the housing 110 and the intermediate member 120, the optical fiber assembly 200 may be effectively fixed in the slot 112. Simply put, the spring sheet 130 may be regarded as a fastening structure that combines the intermediate member 120 and the housing 110 together.

As shown by the dashed lines in the partial enlarged view of FIG. 5B, the spring sheet 130 will generate interference with the top surface S2 of the intermediate member 120 at its straight section T1, thereby driving the spring sheet 130 to deform to accumulate the elastic force and form the first force F1.

FIG. 5C illustrates a partial view of the co-packaged photonics fiber connector of FIG. 1A. Referring to FIG. 5B and FIG. 5C at the same time, it should also be mentioned that the intermediate member 120 of the embodiment further includes a stop protrusion 122a that extends from the abutting rib 122 away from the V-shaped slot 125 and protrudes from the outside of the intermediate member 120. The V-shaped slot 125 of the first guide slot CH is located between the groove 124 and the stop protrusion 122a. The side wall 113 of the housing 110 includes an end notch 116 at the second end E2 of the slot 112. Therefore, in the fixed state, the intermediate member 120 is inserted into the slot 112, the stop protrusion 122a fills in the end notch 116 to restrict the intermediate member 120 in the slot 112, so as to prevent the intermediate member 120 from flipping out of the slot 112 due to driving by an elastic force of the spring sheet 130. As shown in FIG. 5B, in addition to providing the force application along the Y-axis to the housing 110, the hook 132 will substantially generate a third force F3 to the housing 110 in response to the inclined surface of the locking portion 118. In this way, the second force F2 and the third force F3 will generate a moment through the shaft portion 121, driving the intermediate member 120 to flip along the dashed arrow shown in FIG. 5B and be removed from the slot 112. Therefore, the embodiment prevents the aforementioned intermediate member 120 from being removed from the slot 112 by the spring sheet 130 through the interference between the stop protrusion 122a shown in FIG. 5C and the side wall 113 at the end notch 116.

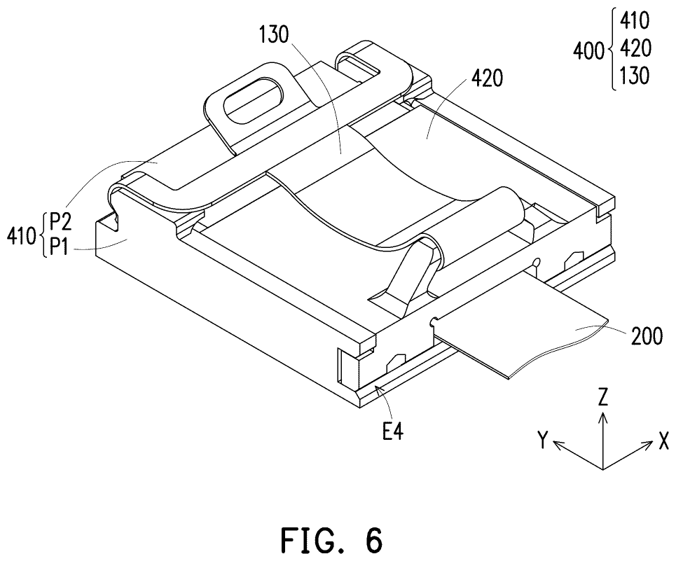

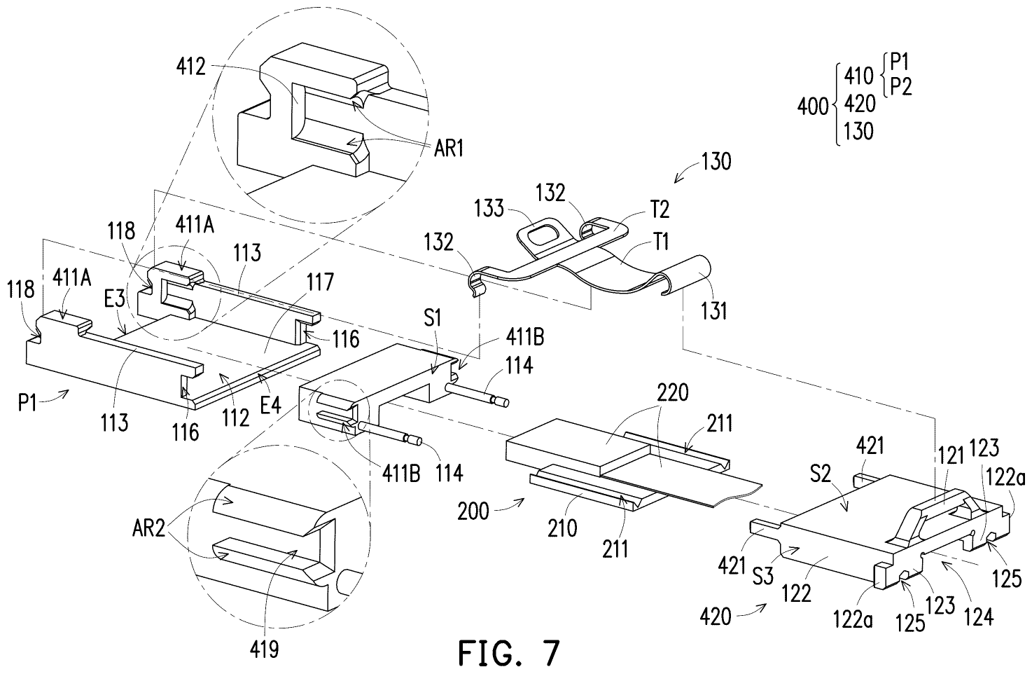

FIG. 6 is a schematic view of a co-packaged photonics fiber connector according to another embodiment of the disclosure. FIG. 7 illustrates an exploded view of the co-packaged photonics fiber connector of FIG. 6. Referring to FIG. 6 and FIG. 7 at the same time, it should be noted first that the structures or component features denoted by the same reference numerals in this embodiment have been mentioned in the aforementioned embodiment, and therefore repeated description is not provided hereinafter.

The difference from the aforementioned embodiment is that a housing 410 of the embodiment is composed of a carrier P1 and a spacer P2. The spacer P2 is assembled to the carrier P1. The spacer P2 includes a first guide post 114 and an inner stop surface S1. The carrier P1 includes a slot 112 and two side walls 113. The slot 112 includes a first end E3 and a second end E4 that are opposite to each other, and the spacer P2, the optical fiber assembly 200, and the intermediate member 420 respectively move from the second end E4 toward the first end E3 to be inserted into the slot 112.

Furthermore, the carrier P1 also includes a first arc-shaped track 411A, located on the side wall 113, and the spacer P2 includes a second arc-shaped track 411B. The second arc-shaped track 411B is configured to the first arc-shaped track 411A such that the spacer P2 is assembled into the carrier P1, and is stopped at the end stop portion 412 of the first arc-shaped track 411A. In the embodiment, the first arc-shaped track 411A includes a pair of arc-shaped inner walls AR1, extending from the end stop portion 412 along the side wall 113, and the second arc-shaped track 411B includes a pair of arc-shaped outer walls AR2, configured to the arc-shaped inner walls AR1 to allow the second arc-shaped track 411B to be substantially inserted into the space between the arc-shaped inner walls AR1. Additionally, a second guide slot 419 is provided between the arc-shaped outer walls AR2, and the intermediate member 420 further includes a second guide post 421, protruding from the inner side surface S3 and configured to the second guide slot 419. The second guide post 421 and the second guide slot 419 are configured to each other guide and position the intermediate member 420 and the spacer P2 relative to each other during the process of inserting the intermediate member 420 into the slot 112.

Compared with the embodiments shown in the aforementioned FIG. 1A to FIG. 5B, the embodiment is provided according to assembly requirements, in which the embodiment further divides the housing 410 into a carrier P1 and a spacer P2, thereby facilitating operators to first assemble the spacer P2, the intermediate member 420, and the optical fiber assembly 200, and then insert the combined three components together into the carrier P1 having the slot 112. It should be noted that a co-packaged photonics fiber connector 400 of the disclosure has external dimensions (length, width, height) of approximately 18 mm, 18 mm, 6.5 mm, which is not easy for operators to operate and results in reduced work efficiency. Therefore, through the structural reconfiguration of the housing 410 in the embodiment, the assembly efficiency may be significantly improved.

In summary, in the co-packaged photonics fiber connector of the above embodiments of the disclosure, the spring sheet is assembled to the housing and is able to pivotally rotate relative to the housing. After the optical fiber assembly is inserted into the slot together with the intermediate member that covers the optical fiber assembly, one end of the spring sheet may be locked with and pivotally connected to the shaft portion of the intermediate member, and another end of the spring sheet may be locked with an external structure of the housing facing away from the slot. In this way, the spring sheet may lock and combine the intermediate member and the housing together, and further allow the optical fiber assembly to be fixed in the slot and be pressed between the intermediate member and the housing.

In one embodiment, the housing has an integral structure, that is, the block and side wall belonging to the same structure may be manufactured through a single process to have better mechanical precision which is favorable for carrying and fixing the optical fiber assembly. In one embodiment, the housing is assembled from a carrier and a spacer that are separated from each other, in which the carrier includes a slot, and the spacer includes an inner stop surface for the intermediate member to abut. This allows the optical fiber assembly to be first assembled with the intermediate member and the spacer before, and then inserted into the slot of the housing, such that the effect of changing the assembly sequence may be achieved by utilizing the structural reconfiguration of the housing, which is favorable for improving the convenience and efficiency of the assembly process.

Based on the above, such an arrangement of the co-packaged photonics fiber connector not only allows the optical fiber assembly and the PIC to achieve rapid assembly and disassembly through the cooperation between the spring sheet, housing, and intermediate member, but also ensures that the spring sheet pivoted to the intermediate member may hook onto the housing to provide an effective binding force after the intermediate member is inserted into the slot. More importantly, the spring sheet is only locked with and abutted against the housing and the intermediate member, and will not have direct structural contact with the optical fiber assembly. Therefore, it may effectively achieve the purpose of protecting the optical fiber assembly through the intermediate member, thereby further providing a stable assembly mechanism for the optical fiber assembly and the PIC and improving the lifetime of the optical fiber assembly.

What is claimed is:

1. A photonics fiber connector, disposed on a photonic integrated circuit (PIC), and configured to receive an optical fiber assembly and optically couple the optical fiber assembly to the PIC, the photonics fiber connector comprising:
a housing, mounted on the PIC, and having a slot, wherein the optical fiber assembly is configured to be inserted into the slot or removed from the slot;
an intermediate member, configured to be inserted into the slot or removed from the slot, and having a shaft portion; and
a spring sheet, wherein a portion of the spring sheet is pivotally connected to the shaft portion to pivotally rotate relative to the intermediate member,
wherein in a fixed state, the optical fiber assembly is inserted into the slot, the intermediate member is inserted into the slot and covers the optical fiber assembly, another portion of the spring sheet is locked with the housing to assemble the intermediate member and the housing together, and the spring sheet presses the optical fiber assembly through the intermediate member to secure the optical fiber assembly in the slot of the housing.

2. The photonics fiber connector according to claim 1, wherein the housing comprises two side walls and an inner stop surface defining the slot, the two side walls are opposite to each other, the inner stop surface is adjacent between the two side walls, and in the fixed state, an inner side surface of the intermediate member abuts the inner stop surface.

3. The photonics fiber connector according to claim 2, wherein the housing further comprises a first guide post extending from the inner stop surface along the side wall within the slot, and at least one of the intermediate member and the optical fiber assembly comprises a first guide slot such that the first guide post is configured to the first guide slot to guide and position the intermediate member and the optical fiber assembly in the slot during an insertion of the optical fiber assembly and the intermediate member into the slot.

4. The photonics fiber connector according to claim 3, wherein the housing comprises a carrier and a spacer, the spacer is assembled to the carrier, the spacer comprises the first guide post and the inner stop surface, and the carrier comprises the slot and the two side walls.

5. The photonics fiber connector according to claim 4, wherein the carrier further comprises a first arc-shaped track located at the side wall, the spacer comprises a second arc-shaped track, and the spacer is assembled into the carrier by the second arc-shaped track being configured to the first arc-shaped track, and is stopped by an end stop portion of the first arc-shaped track.

6. The photonics fiber connector according to claim 5, wherein the first arc-shaped track comprises a pair of arc-shaped inner walls extending from the end stop portion, and the second arc-shaped track comprises a pair of arc-shaped outer walls configured to the pair of arc-shaped inner walls.

7. The photonics fiber connector according to claim 6, wherein a second guide slot is provided between the pair of arc-shaped outer walls, the intermediate member further comprises a second guide post protruding from the inner side surface and configured to the second guide slot, and the second guide post and the second guide slot are configured to each other to guide and position the intermediate member and the spacer relative to each other during the insertion of the intermediate member into the slot.

8. The photonics fiber connector according to claim 3, wherein the optical fiber assembly comprises an optical module and a base, the optical module is disposed on the base, and a wing portion of the base protruding from the optical module comprises the first guide slot.

9. The photonics fiber connector according to claim 2, wherein the housing comprises a hollow portion facing the PIC and communicating with the slot, the optical fiber assembly comprises an optical module and a base, the optical module is disposed on the base, in the fixed state, the base is located in the slot and abuts the inner stop surface, and the optical module extends from the slot to the hollow portion to correspond to the PIC.

10. The photonics fiber connector according to claim 2, wherein the housing further comprises a block and a base plate, the block comprises the inner stop surface, the base plate and the two side walls extend from the block in a same direction and form the slot with the inner stop surface.

11. The photonics fiber connector according to claim 1, wherein the spring sheet has a T-shape and comprises a transverse section and a straight section, the straight section intersects at a center of the transverse section, an end of the straight section away from the transverse section comprises a pivot portion, the pivot portion is able to pivotally rotate to wrap around the shaft portion, the straight section has a bent shape, and in the fixed state, the straight section deforms to accumulate an elastic force due to an interference with a top surface of the intermediate member such that a first force is applied to the top surface to press the intermediate member in the slot, and press the optical fiber assembly between the intermediate member and a slot bottom of the slot.

12. The photonics fiber connector according to claim 11, wherein two opposite ends of the transverse section each have a hook, and in the fixed state, the hook is locked with an external structure of the housing facing away from the slot.

13. The photonics fiber connector according to claim 12, wherein in the fixed state, the hook applies a second force to the housing and the intermediate member to press the optical fiber assembly between the intermediate member and the housing.

14. The photonics fiber connector according to claim 11, wherein the spring sheet further comprises a pull handle extending from the center of the transverse section and opposite to the straight section.

15. The photonics fiber connector according to claim 1, wherein the slot comprises a first end and a second end opposite to each other, the optical fiber assembly and the intermediate member are configured to move from the second end toward the first end to be inserted into the slot, or move from the first end toward the second end to be removed from the slot, and in the fixed state, the shaft portion of the intermediate member is located at the second end.

16. The photonics fiber connector according to claim 3, wherein the intermediate member has an inverted U-shaped structure and comprises two abutting ribs and a groove located between the two abutting ribs, each of the abutting ribs having the first guide slot, and in the fixed state, the optical fiber assembly is located in the groove.

17. The photonics fiber connector according to claim 16, wherein the intermediate member further comprises a stop protrusion protruding from an outer side of the intermediate member, the first guide slot is located between the groove and the stop protrusion, the slot comprises a first end and a second end opposite to each other, the side wall comprises an end notch located at the second end, in the fixed state, the intermediate member is inserted into the slot, and the stop protrusion fills in the end notch to restrict the intermediate member in the slot, so as to prevent the intermediate member from flipping out of the slot due to driving by an elastic force of the spring sheet.
